(19) United States
(12) Patent Application Publication
(10) Pub. No.: US 2015/0287073 A1
(43) Pub. Date: Oct. 8, 2015

(54) ADVERTISEMENT CAROUSEL SYSTEM

(71) Applicant: TangoMe, Inc., Mountain View, CA (US)

(72) Inventors: Xu LIU, San Jose, CA (US); Richard RABBAT, Palo Alto, CA (US); Paul AUTRAN, Mountain View, CA (US)

(21) Appl. No.: 14/670,171

(22) Filed: Mar. 26, 2015

Related U.S. Application Data
(60) Provisional application No. 61/976,152, filed on Apr. 7, 2014.

(51) Int. Cl. G06Q 30/02

(52) U.S. Cl. CPC G06Q 30/0246; G06Q 30/0277

(57) ABSTRACT

A method for enabling browsing of multiple advertisement units via an advertisement carousel is described. The method includes: integrating advertisement units from multiple vendors into an advertisement carousel; displaying at least one advertisement unit of the advertisement units in response to a display instruction; and capturing an impression time for the at least one advertisement units.

### REFERENCE TO RELATED APPLICATIONS

This application claims the benefit of co-pending U.S. Patent Application No. 61/976,152 filed on Apr. 7, 2014 entitled “AD CAROUSEL IN A FEED TO ALLOW FOR HORIZONTAL BROWSING OF MULTIPLE ADVERTISING UNITS” by Liu et al., having Attorney Docket No. TNGO-032.PRO, and assigned to the assignee of the present application, and is hereby incorporated by reference in its entirety herein.

### BACKGROUND

Mobile devices have limited screen size, so advertisments placed on the screen are shown within the screen size limit. Further, advertisements from different advertisement networks are shown on the same screen with a limited size.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 illustrates an example advertising unit “A”, as part of a series of advertising units “A”, “B” and “C” located next to each other on an advertisement carousel, being displayed on a display screen of a mobile device, in accordance with an embodiment.

FIG. 2 illustrates an example advertising unit “B” as part of a series of advertising units “A”, “B” and “C” located next to each other on an advertisement carousel, being displayed on a display screen of a mobile device, in accordance with an embodiment.

FIG. 3 illustrates an example advertising unit “C” as part of a series of advertising units “A”, “B” and “C” located next to each other on an advertisement carousel, being displayed on a display screen of a mobile device, in accordance with an embodiment.

FIG. 4 is a block diagram that illustrates an embodiment of an advertisement carousel system, in accordance with an embodiment.

FIG. 5 depicts a flow diagram for a method for enabling horizontal browsing of multiple advertisement units via an advertisement carousel, in accordance with an embodiment.

FIG. 6 is a block diagram of an example computer system with which or upon which various embodiments of the present invention may be implemented.

### DESCRIPTION OF EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### Notation and Nomenclature

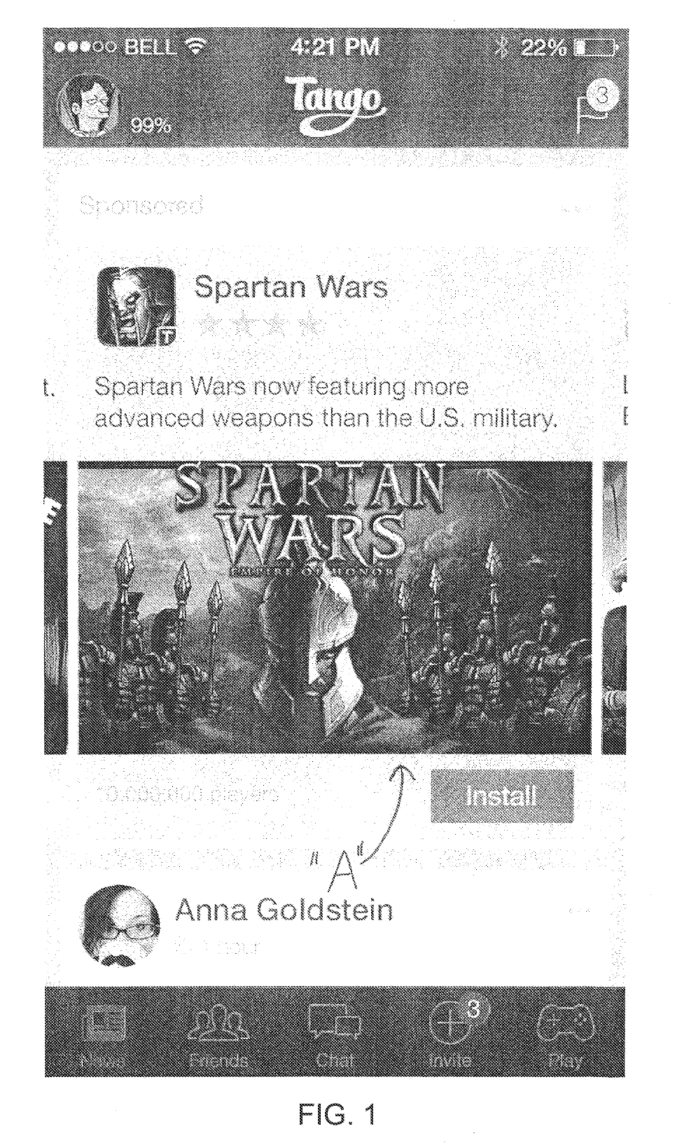

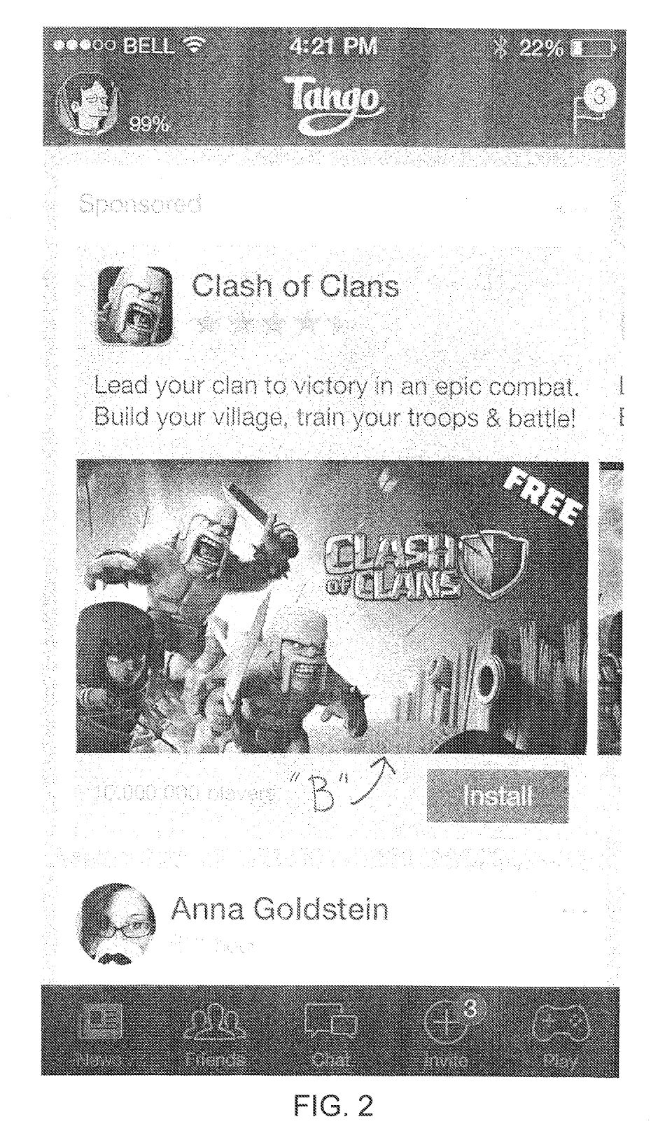

Unless specifically stated otherwise as apparent from the following discussions, it is appreciated that throughout the present Description of Embodiments, discussions utilizing terms such as “accesses,” “receives”, “sends”, “compares”, “generates”, “sends”, or the like, often refer to the actions and processes of an electronic computing device (or portion thereof), module or system, such as, but not limited to, an advertisement carousel system (See FIGS. 1 and 2), unless noted otherwise. The electronic computing device/module/system transmits, receives, stores, manipulates and/or transforms signals represented as physical (electrical) quantities within the circuits, components, logic, and the like, of the electronic computing device/system into other signals similarly represented as physical electrical quantities within the electronic computing device/system or within or transmitted to other electronic computing devices/systems.

### Overview of Embodiments and Discussion

Conventional mobile devices have a limited screen size, so advertisements placed to be presented on the display screen are shown within this screen size limit. Further, advertisements from different advertisement networks are shown on the same display screen at the same time, wherein the display screen has a limited size. Embodiments of the present technology provide for an advertisement carousel in a feed or profile mode, during the operation of a mobile device, which allows for the horizontal browsing of multiple advertising units on the limited size of the display screen.

As will be described below, embodiments create an advertising space for users who would like to browse more advertisements to, for example, pick games they like or an application that they want to install on their mobile device(s). Embodiments allow for the mixing of advertisements from different advertisement networks into a single advertisement unit. In some embodiments, this technology is applied to a feed and profile mode, whereas traditional banner or interstitial advertisements present one advertisement at a time at a display screen. Embodiments also provide a carousel that anticipates advertisement requests and provides multiple advertisements during a user's scroll time while also ordering these advertisements by the highest effective cost per mill (“eCPM) to the lowest eCPM, thereby increasing revenue and optimizing for revenue. Static advertisements do not allow this optimization. Once in scrolling mode, embodiments enable the advertisement carousel to significantly increase the chance of an impression occurring per request from a user to access the advertisement carousel. An impression is considered to have occurred if any advertisement in the advertisement carousel is shown for more than a particular time period and if greater than a certain percentage of the advertisement (or “ad unit”) is showing. For example, an impression occurs, in one embodiment, if the advertisement unit in the advertisement carousel (to which the user scrolled) is shown for more than one second, and if the portion of the advertisement unit that shown during that one second is greater than 50% of the advertisement unit. Other conventional advertising formats have no way to predict an occurrence of an impression.

Thus, embodiments allow for the growth of impressions for a current user base without being too intrusive for the user. The operation of the advertisement carousel is user-driven, thereby allowing a user who wants to see more advertisements to browse these advertisements in the feed and/or in a profile.

FIGS. 1, 2 and 3 are an example of an embodiment of an advertisement carousel that allows for horizontal browsing of multiple advertising units. For example, FIG. 1 illustrates an example advertisment unit “A” as part of a series of advertisement units “A”, “B” and “C” located next to each other on an advertisement carousel, being displayed on a display screen of a mobile device, in accordance with an embodiment. The advertisement unit “A” is located next to advertisement unit “B” on the advertisement carousel. If scrolled to the right, the advertisement unit “B” will be visible.

FIG. 2 illustrates an example advertisement unit “B” as part of a series of advertisement units “A”, “B” and “C” located next to each other on an advertisement carousel, being displayed on a display screen of a mobile device, in accordance with an embodiment. The advertisement unit “B” is located next to advertisement unit “A” on its left and advertisement unit “B” on its right of the advertisement carousel. If scrolled to the right, the advertisement unit “C” will be visible.

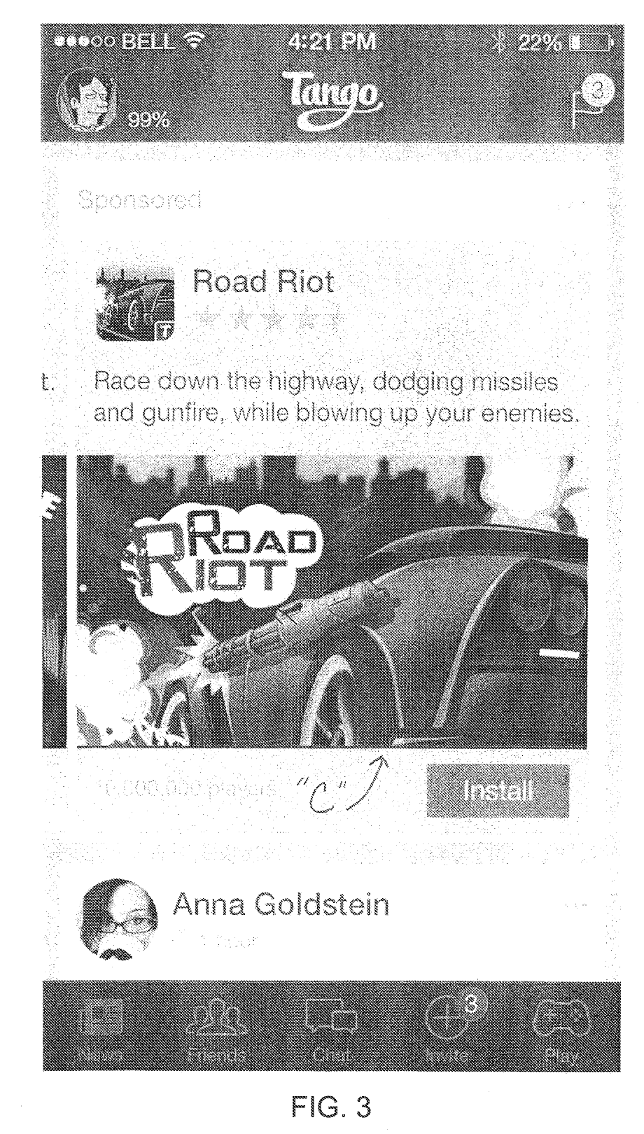

FIG. 3 illustrates an example advertising unit “C” as part of a series of advertisement units “A”, “B” and “C” located next to each other on an advertisement carousel, being displayed on a display screen of a mobile device, in accordance with an embodiment. The advertisement unit “C” is located next to advertisement unit “B” on its left. If scrolled to the left, the advertisement unit “B” will be visible.

In one embodiment, the number of advertisements in each advertisement carousel is fixed at a particular quantity, such as, for example, ten. In one embodiment, each advertisement in the advertisement carousel is the same size. In one embodiment, a single advertisement unit and the advertisement carousel are never displayed next to each other. In one embodiment, then the advertisement carousel is presented at the display screen, the visible area of at the display screen always includes one full creative (of the advertisement unit), and depending on the position of the advertisement unit in the carousel, a partial creative either to the left of the advertisement unit or to the right of the advertisement unit. Thus, this type of positioning gives a hint to the viewing user to scroll left and/or right to access more advertisement units.

In one embodiment, advertisements from multiple advertisement networks are mixed together. In this manner, revenue may be increased by selecting advertisements for the advertisement carousel based on the rates that an advertisement network provides. Revenue may be further increased by computing the effective cost per mille (“eCPM”) rate that is collected from advertisement networks for each advertisement unit and organizing these advertisement units in the advertisement carousel from the highest eCPM (being first) to the lowest eCPM (being last).

In one embodiment, any scrolling performed in the advertisement carousel should be “memory-full”. That is, a user scrolls to the second advertisement unit from the first advertisement unit and then to the third advertisement unit from the second advertisement unit, thereby navigating down the feed. The user then navigates back to the first advertisement unit. At this position, embodiments show the advertisement carousel at the same position. Any tab that the user leaves or comes back to will behave in the same way at any time at which the user accesses the advertisement unit. In one embodiment, the advertisement carousel allows for infinite scrolling.

In one embodiment, the advertisement carousel is cyclic; the advertisement carousel cycles back to the beginning advertisement instead of showing left and right boundaries. In the case of a cyclic advertisement carousel, in one embodiment, the advertisement carousel will request new advertisements to replace advertisements that have already been shown (presented at the display screen to the user). In this manner, revenue may also be increased by increasing the number of advertisements that are shown to a user, thereby gaining revenue for each impression of a new advertisement unit. In one embodiment, the clickthrough rate (CTR) is measured for each placement of each advertisement unit. In one embodiment, a “refresh” of the advertisement carousel moves all of the advertisement units to a beginning position. In one embodiment, a subset of advertisement units is initially shown. As the user scrolls left and right in the advertisement carousel, the advertisement carousel logic will request more advertisement units in anticipation of further scrolling.

Thus, embodiments provide for displaying an advertisement carousel, that is made up of multiple advertisement units from multiple advertisement networks, that allows a user to browse (e.g., horizontal and/or vertical browsing) advertisement units thereon. These advertisement units are organized on the advertisement carousel such that the advertisement units for which a company paid the most to display are presented before lower costing advertisement units are presented, thereby encouraging a higher price to be paid for premium advertising space. Embodiments also provide that in each view of the advertisement carousel, at least one full advertisement unit and a second partial advertisement unit will be displayed, giving the viewer/user a hint as to which advertisement unit is to the left of the right of the full advertisement unit that is being displayed. Further, embodiments anticipate the need for more advertisement units to be added into the carousel, either upon the scrolling left and right performed by the user or by the quantity of impressions recorded as having occurred.

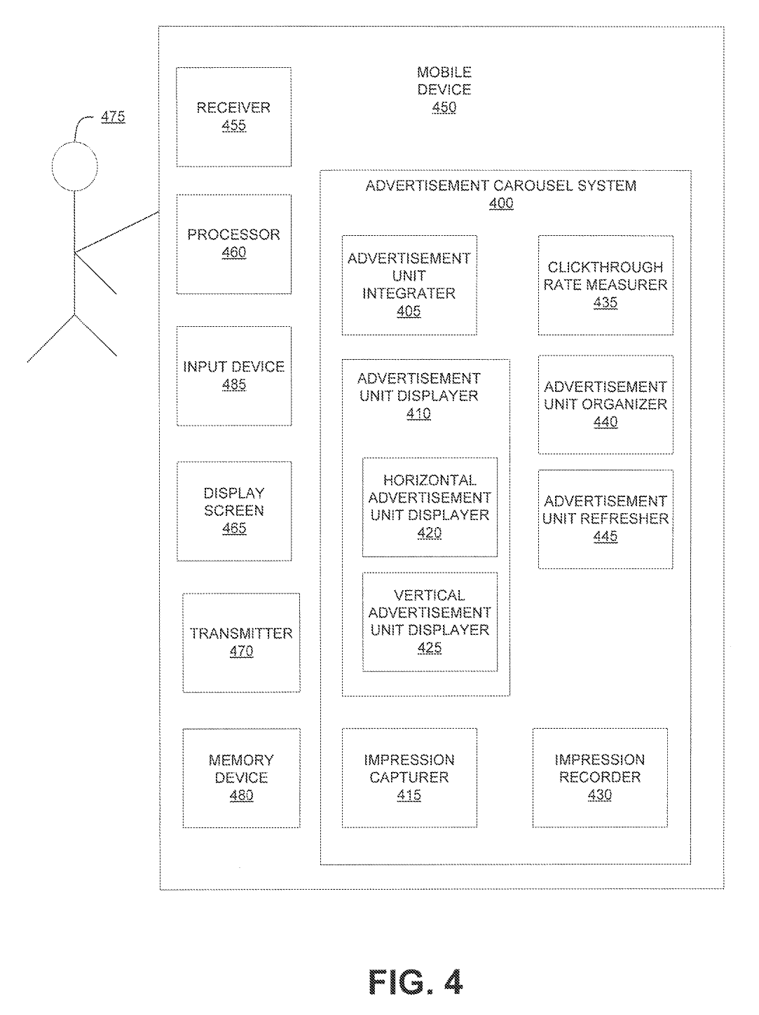

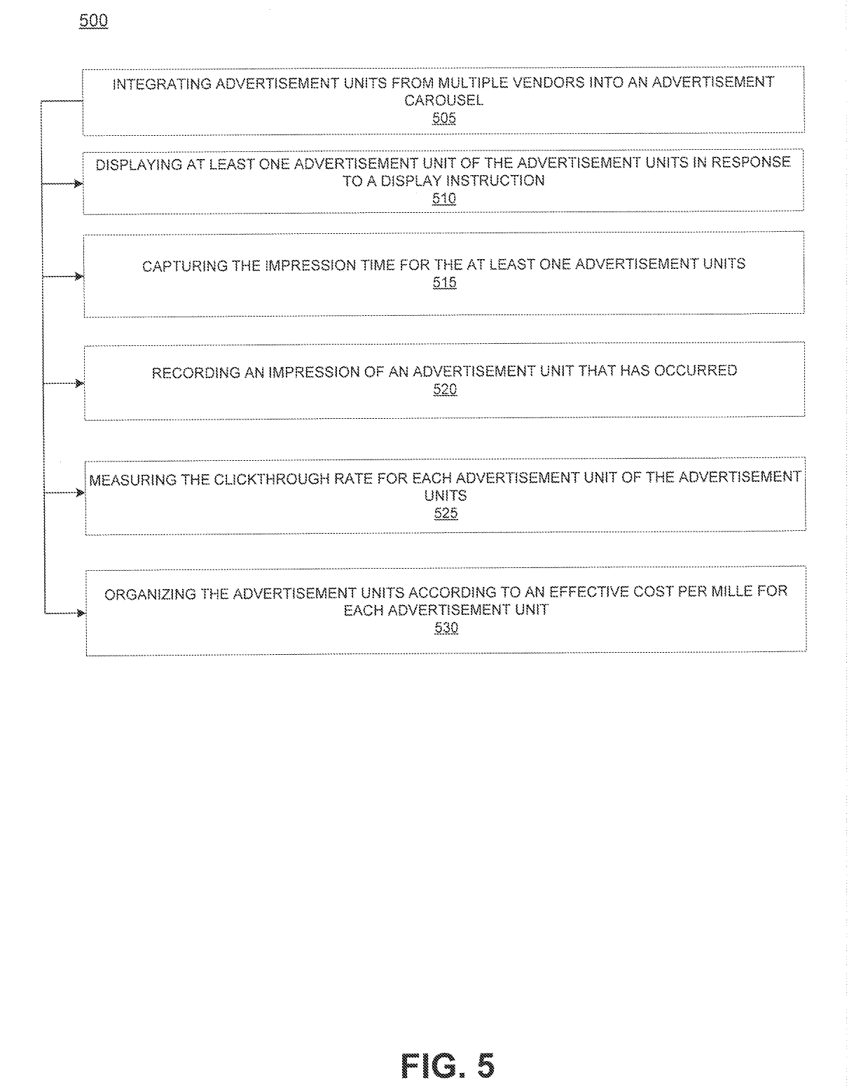

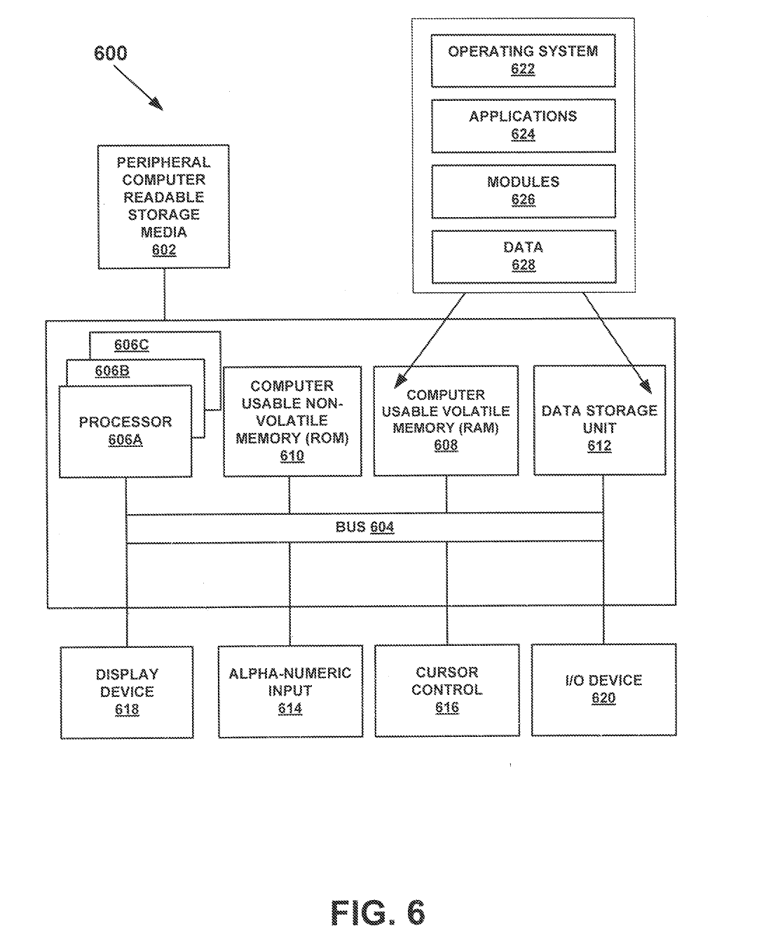

The following discussion will begin with a description of the advertisement carousel system, with reference to FIG. 4. The discussion will follow with a description of a method of operation for enabling horizontal browsing of multiple advertisement units via an advertisement carousel, with reference to FIGS. 4 and 5. With reference to FIG. 6, the discussion concludes with a description of an example computer system with which or upon which various embodiments of the present technology may be implemented.

### Advertisement Carousel System

FIG. 4 depicts a block diagram that illustrates an advertisement carousel system 400 that includes the following modules coupled with a computer, such as computer 600 of FIG. 6: an advertisement unit integrater 405; an advertisement unit displayer 410; and an impression capturer 415. The advertisement unit displayer 410 optionally includes any of the following modules: a horizontal advertisement unit displayer 420; and a vertical advertisement unit displayer 425. The advertisement carousel system 400 optionally includes the following modules coupled with a computer, such as the computer 600: an impression recorder 430; a clickthrough rate measurer 435; an advertisement unit organizer 440; and an advertisement unit refresher 445. FIG. 4 also shows the advertisement carousel system 400 residing at the mobile device 450.

Also shown in FIG. 4 and located at the mobile device 450 are the following components: a receiver 455; a processor 460; a display screen 465; a transmitter 470; and a memory device 480. In one embodiment, the memory device 480 is part of the advertisement carousel system 400. In another embodiment, the memory device 480 is remote from, but communicatively coupled with, the advertisement carousel system 400. In one embodiment, the advertisement carousel system 400 resides at a server. Thus, in one embodiment, the memory device 480 is located at a server. In another embodiment, the memory device 480 is remote from, but communicatively coupled with, the server.

The advertisement carousel system 400 will now be discussed, with reference to FIG. 4. The advertisement unit integrater 405 integrates advertisement units from multiple vendors into an advertisement carousel.

The advertisement unit displayer 410 displays at least one advertisement unit of the advertisement units in response to a display instruction. The display instruction is a request communicated to the advertisement carousel system 400 for a particular advertisement unit to be presented to the user in a particular font and format. This font and format may be that font and format that is established as a factory, default setting, in one embodiment. In another embodiment, the font and format may be a font and format that is established by the user. In one embodiment, the advertisement unit displayer 410 optionally includes: a horizontal advertisement unit displayer 420 configured for displaying, via the advertisement carousel, the at least one advertisement unit such that the advertisement carousel may be browed horizontally; and a vertical advertisement unit displayer 425 configured for displaying, via the advertisement carousel, the at least one advertisement unit such that the advertisement carousel may be browed vertically.

The impression capturer 415 captures an impression time for the at least one advertisement units. As described herein, the impression time is defined by the application developers of the advertisement carousel system 400. For example, the impression time may be defined as the time that an advertisement in the advertisement carousel is shown for more than one second and that which is showing (being displayed) is greater than 50% of the advertisement unit. In another embodiment, the impression time is defined as the time that an advertisement in the advertisement carousel is shown for more than ½ second and that which is showing (being displayed) is greater than 75% of the advertisement unit. However, it should be noted that the impression time may be defined as any combination of events occurring.

In one embodiment, the advertisement carousel is cyclic. In another embodiment, each advertisement unit of the advertisement units is the same size. In one embodiment, the advertising networks are responsible for sizing their advertisements according to the size at which the advertisement unit will be displayed. In one embodiment, the advertisement carousel occurs in a feed mode. In another embodiment, the advertisement carousel occurs in a profile mode.

The impression recorder 430 records an impression of an advertisement unit having occurred. Impressions that are recorded are stored at the memory device 480.

The clickthrough rate measurer 435 measures a clickthrough rate for each advertisement unit of the advertisement units.

The advertisement unit organizer 440 organizes the advertisement units according to an effective cost per mille for each advertising unit.

The advertisement unit refresher 445, upon activation, moves the advertisement carousel to a beginning position such that a beginning advertisement unit of the advertisement units is displayed. The activation is that which is an instruction to refresh the advertisement carousel. This instruction may be from an input to the mobile device and hence an input to the advertisement carousel system, or the instruction may be a preprogrammed instruction to refresh upon the occurrence of a certain event. For example, the advertisement carousel system may be preprogrammed to refresh after two minutes has passed following an interaction with the user of the mobile device.

FIG. 4 also shows the mobile device 450 as optionally including in various embodiments the following: the receiver 455; the processor 460; the display screen 465; the transmitter 470; the memory device 480; and an input device 485.

The input device 485 is configured for receiving a display instruction to display at least one advertisement unit of advertisement units. The input device 485, in one embodiment, is that I/O device 620 of FIG. 6, described herein below.

The processor 310 is configured for executing the methods described herein at least with regard to the advertisement carousel system 400. The processor 460 may be implemented, for example, by one or more discrete modules (or data processing components) that are not limited to any particular hardware, firmware, or software (i.e., machine readable instructions) configuration. The processor 460 may be implemented in any computing or data processing environment, including in digital electronic circuitry, e.g., an application-specific integrated circuit, such as a digital signal processor (DSP) or in computer hardware, firmware, device driver, or software (i.e., machine readable instructions). In some implementations, the functionalities of the modules are combined into a single data processing component. In other versions, the respective functionalities of each of one or more of the modules are performed by a respective set of multiple data processing components.

The processor 460 is configured for, at least, performing the following processing steps: integrating the advertisement units from multiple vendors into an advertisement carousel; displaying the at least one advertisement unit of the advertisement units in response to a display instruction; and capturing an impression time for the at least one advertising units. In one embodiment, the processor 460 is further configured for causing to be displayed, via the advertisement carousel, the at least one advertisement unit such that the advertisement carousel may be browsed horizontally. In another embodiment, the processor 460 is configured for causing to be displayed, via the advertisement carousel, the at least one advertisement unit such that the advertisement carousel may be browsed vertically. The processor 460 is further optionally configured for the performing at least the following processes: recording an impression of an advertisement unit having occurred; measuring a clickthrough rate for each advertisement unit of the advertisement units; and organizing the advertisement units according to an effective cost per mille for each advertising unit;

The memory device 480 stores process instructions (e.g., machine-readable code, such as computer software) for implementing methods executed by processor 460, as well as data that processor 460 generates or processes, as is discussed herein. The memory device 480 may include one or more tangible machine-readable storage media. Memory devices suitable for embodying these instructions and data include all forms of computer-readable memory, including, for example, semiconductor memory devices, such as EPROM, EEPROM, and flash memory devices, magnetic disks such as internal hard disks and removable hard disks, magneto-optical disks, and ROM/RAM devices.

The receiver 455 is configured for, at least, receiving display instructions remotely. Thus, instead of a user typing in display instructions into the input device 485 of the mobile device 450, the user communicates the display instructions to a device remote from the mobile device 450, which then, wirelessly, communicates this to the mobile device 450.

### Example Methods of Operation

The following discussion sets forth in detail some example methods of operation of embodiments. With reference to FIGS. 1-5, a flow diagram of method 500 for enabling browsing of multiple advertisement units via an advertisement carousel is shown, in accordance with embodiments. Method 500 includes some procedures that, in various embodiments, are carried out by a processor under the control of computer-readable and computer-executable instructions. In various embodiments, these computer-readable and computer-executable instructions are described as “code segments”, and presented separately (e.g., first codes segment, second code segment, etc.) to describe such instructions. In this fashion, procedures described herein and in conjunction with these flow diagrams, alone or in combination, are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, and optical disks, solid-state disks, any or all of which may be employed within a virtualization infrastructure. The computer-readable and computer-executable instructions, which reside on tangible computer readable storage media, are used to control or operate in conjunction with, for example, one or some combination of processors of a virtual machine. It is appreciated that the processor(s) may be physical or virtual or some combination (it should also be appreciated that a virtual processor is implemented on physical hardware).

The following discussion of method 500 references FIGS. 1-5 unless specifically noted otherwise.

At step 505 of method 500, in one embodiment and as described herein, the advertisement units from multiple vendors are integrated into an advertisement carousel.

At step 510 of method 500, in one embodiment and as described herein, the at least one advertisement unit of the advertisement units is displayed in response to a display instruction. In one embodiment, the advertisement carousel is displayed such that the advertisement carousel may be browsed horizontally. In another embodiment, the advertisement carousel is displayed such that the advertisement carousel may be browsed vertically.

At step 515 of method 500, in one embodiment and as described herein, the impression time for the at least one advertisement units is captured.

At step 520 of method 500, in one embodiment and as described herein, the impression of an advertisement unit having occurred is recorded.

At step 525 of method 500, in one embodiment and as described herein, the clickthrough rate for each advertisement unit of the advertisement units is measured.

At step 530 of method 500, in one embodiment and as described herein, the advertisement units are organized according to an effective cost per mille for each advertisement unit.

### Example Computer System

With reference now to FIG. 6, all or portions of some embodiments described herein are composed of computer-readable and computer-executable instructions that reside, for example, in computer-usable/computer-readable storage media of a computer system. That is, FIG. 6 illustrates one example of a type of computer (computer system 400) that can be used in accordance with or to implement various embodiments which are discussed herein. It is appreciated that computer system 600 of FIG. 6 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, distributed computer systems, media centers, handheld computer systems, multi-media devices, and the like. Computer system 600 of FIG. 6 is well adapted to having peripheral non-transitory computer-readable storage media 602 such as, for example, a floppy disk, a compact disc, digital versatile disc, other disc based storage, universal serial bus “thumb” drive, removable memory card, and the like coupled thereto.

System 600 of FIG. 6 includes an address/data bus 604 for communicating information, and a processor 606A coupled with bus 604 for processing information and instructions. As depicted in FIG. 6, system 600 is also well suited to a multi-processor environment in which a plurality of processors 606A, 606B, and 606C are present. Conversely, system 600 is also well suited to having a single processor such as, for example, processor 606A. Processors 606A, 606B, and 606C may be any of various types of microprocessors, and may be the processor 602 described with respect to FIGS. 4 and 5. System 600 also includes data storage features such as a computer usable volatile memory 608, e.g., random access memory (RAM), coupled with bus 604 for storing information and instructions for processors 606A, 606B, and 606C.

System 600 also includes computer usable non-volatile memory 610, e.g., read only memory (ROM), coupled with bus 604 for storing static information and instructions for processors 606A, 606B, and 606C. In one embodiment, the memory device 480 of FIGS. 4 and 5 is an example the computer usable volatile memory 608 and/or the computer usable non-volatile memory 610. Also present in system 600 is a data storage unit 612 (e.g., a magnetic or optical disk and disk drive) coupled with bus 604 for storing information and instructions. System 600 also includes an optional alphanumeric input device 614 including alphanumeric and function keys coupled with bus 604 for communicating information and command selections to processor 606A or processors 606A, 606B, and 606C. System 600 also includes an optional cursor control device 616 coupled with bus 604 for communicating user input information and command selections to processor 606A or processors 606A, 606B, and 606C. In one embodiment, system 600 also includes an optional display device 618 coupled with bus 604 for displaying information.

Referring still to FIG. 6, optional display device 618 of FIG. 6 may be a liquid crystal device, cathode ray tube, plasma display device or other display device suitable for creating graphic images and alphanumeric characters recognizable to a user. Optional cursor control device 616 allows the computer user to dynamically signal the movement of a visible symbol (cursor) on a display screen of display device 618 and indicate user selections of selectable items displayed on display device 618. Many implementations of cursor control device 616 are known in the art including a trackball, mouse, touch pad, joystick or special keys on alphanumeric input device 614 capable of signaling movement of a given direction or manner of displacement. Alternatively, it will be appreciated that a cursor can be directed and/or activated via input from alphanumeric input device 614 using special keys and key sequence commands. System 600 is also well suited to having a cursor directed by other means such as, for example, voice commands. System 600 also includes an I/O device 620 for coupling system 600 with external entities. For example, in one embodiment, I/O device 620 is a modem for enabling wired or wireless communications between system 600 and an external network such as, but not limited to, the Internet.

Referring still to FIG. 6, various other components are depicted for system 600. Specifically, when present, an operating system 622, applications 624, modules 626, and data 628 are shown as typically residing in one or some combination of computer usable volatile memory 608 (e.g., RAM), computer usable non-volatile memory 610 (e.g., ROM), and data storage unit 612. In some embodiments, all or portions of various embodiments described herein are stored, for example, as an application 624 and/or module 626 in memory locations within RAM 608, computer-readable storage media within data storage unit 612, peripheral computer-readable storage media 602, and/or other tangible computer-readable storage media.

What we claim is:

1. An article of manufacture, which comprises a computer readable medium having stored therein a computer program for enabling browsing of multiple advertisement units via an advertisement carousel, said computer program comprising:
a first code segment which, when executed on a computer, integrates advertisement units from multiple vendors into an advertisement carousel;
a second code segment which, when executed on said computer, displays at least one advertisement unit of said advertisement units in response to a display instruction; and
a third code segment which, when executed on said computer, captures an impression time for said at least one advertisement units.

2. The article of manufacture of claim 1, wherein said second code segment comprises:
displaying, via said advertisement carousel, said at least one advertisement unit such that said advertisement carousel may be browsed horizontally.

3. The article of manufacture of claim 1, wherein said second code segment comprises:
displaying, via said advertisement carousel, said at least one advertisement unit such that said advertisement carousel may be browsed vertically.

4. The article of manufacture of claim 1, further comprising:
a fourth code segment which, when executed on said computer, records an impression of an advertisement unit having occurred.

5. The article of manufacture of claim 1, further comprising:
a fifth code segment which, when executed on said computer, measures a clickthrough rate for each advertisement unit of said advertisement units.

6. The article of manufacture of claim 1, further comprising:
a sixth code segment which, when executed on said computer, organizes said advertisement units according to an effective cost per mille for each advertisement unit.

7. The article of manufacture of claim 1, wherein said advertisement carousel is cyclic.

8. A system comprising:
an advertisement unit integrater coupled with a computer, said advertisement unit integrater configured for integrating advertisement units from multiple vendors into a an advertisement carousel;
an advertisement unit displayer coupled with said computer, said advertisement unit display configured for displaying at least one advertisement unit of said advertisement units in response to a display instruction; and
an impression capturer coupled with said computer, said impression capturer configured for capturing an impression time for said at least one advertisement units.

9. The system of claim 8, wherein said advertisement unit displayer comprises:
a horizontal advertisement unit displayer coupled with said computer, said advertisement unit displayer configured for displaying, via said advertisement carousel, said at least one advertisement unit such that said advertisement carousel may be browsed horizontally.

10. The system of claim 8, wherein said advertisement unit displayer comprises:
a vertical advertisement unit displayer coupled with said computer, said advertisement unit displayer configured for displaying, via said advertisement carousel, said at least one advertisement unit such that said advertisement carousel may be browsed vertically.

11. The system of claim 8, further comprising:
an impression recorder coupled with said computer, said impression recorder configured for recording an impression of an advertisement unit having occurred.

12. The system of claim 8, further comprising:
a clickthrough rate measurer coupled with said computer, said clickthrough rate measurer configured for measuring a clickthrough rate for each advertisement unit of said advertisement units.

13. The system of claim 8, further comprising:
an advertisement unit organizer coupled with said computer, said advertisement unit organizer configured for organizing said advertisement units according to an effective cost per mille for each advertisement unit.

14. The system of claim 8, wherein said advertisement carousel is cyclic.

15. The system of claim 8, wherein each advertisement unit of said advertisement units is the same size.

16. The system of claim 8, further comprising:
an advertisement unit refresher coupled with said computer, said advertisement unit refresher configured for, upon activation, moving said advertisement carousel to a beginning position such that a beginning advertisement unit of said advertisement units is displayed.

17. The system of claim 8, wherein said advertisement carousel occurs in a feed mode.

18. The system of claim 8, wherein said advertisement carousel occurs in a profile mode.

19. An advertisement carousel system comprising:
an input device configured for:
receiving a display instruction to display at least one advertisement unit of advertisement units; and
a processor configured for:
integrating said advertisement units from multiple vendors into an advertisement carousel;
displaying said at least one advertisement unit of said advertisement units in response to a display instruction; and
capturing an impression time for said at least one advertisement units.
